(19) United States
(12) Patent Application Publication
(10) Pub. No.: US 2026/0208413 A1
(43) Pub. Date: Jul. 23, 2026

(54) A TOOL AND METHOD FOR MANUFACTURING AN OVER-MOLDED STRUCTURAL THERMOPLASTIC COMPOSITE HYBRID PART WITH AESTHETIC INTEGRATION

(71) Applicant: SABIC GLOBAL TECHNOLOGIES B.V., Bergen op Zoom (NL)

(72) Inventors: Koffi Leonard DAGNON, COMMERCE TOWNSHIP, MI (US); Nicole JACOBS, Brighton, MI (US); Sandeep Chandrakant KULKARNI, Maastricht (NL); Matthew Adam MERIVIRTA, Linden, MI (US); John ALSFASSER, Farmington, MI (US); Theodore L FRYXELL, White Lake Twp, MI (US)

(21) Appl. No.: 19/139,567

(22) PCT Filed: Dec. 14, 2023
(86) PCT No.: PCT/EP2023/085927

§ 371 Date: Jun. 16, 2025

(30) Foreign Application Priority Data
Dec. 15, 2022 (EP) 22213987.5

(51) Int. Cl. B29C 45/16; B29C 45/14

(52) U.S. Cl. CPC B29C 45/1675; B29C 45/1671; B29C 45/14631; B29C 45/14819; B29K 2313/00

(57) ABSTRACT

Disclosed is a process of manufacturing thermoplastic composite hybrid part with structural and aesthetic features injection over-molded on either side of the composite laminate substrate surface in 1-step, 2-shot injection over-molding process. The process utilizes a heated CFRTP composite laminate substrate injection over-molded with a structural long fiber thermoplastic (LFT) material or resin on one side of the substrate in a first cavity of a two-cavity tool. The structure is injection over-molded with a soft-touch chopped short fiber filled thermoplastic material or resin on the other side of the substrate in a second cavity of the tool to achieve a single-piece part with improved aesthetics and haptics with colors representative of automotive outer and inner colors. Parts manufacturing with such 1-step 2-shot thermoplastic composite hybrid injection over-molding technology can be applied in automotive applications such as tailgates, armrests, seating structures, dash panels, etc.

### BACKGROUND

The disclosure is directed to manufacturing tools and more specifically to a multi-cavity tool configured to simultaneously manufacture multiple thermoplastic composite hybrid parts.

Hybrid solutions combining continuous fiber reinforced thermoplastic (CFRTP) composites over-molded with thermoplastic resins are often considered while developing integrated lightweight components. These one-shot thermoplastic composite hybrid injection over-molded solutions offer viable alternatives to multi-piece metallic systems in a vehicle and are used for many automotive applications for lightweighting. A manufacturing readiness level of this thermoplastic composite hybrid technology has matured and this thermoplastic composite hybrid technology is used for automotive structural or semi-structural applications. However, the use of this technology in applications demanding better surface aesthetics is limited as CFRTP surface is not aesthetically appealing. The aesthetic aspects of the thermoplastic composite hybrid parts are obtained through secondary operations with painting, extra trim layer or foaming. For example, an armrest has an injected foam layer with cloth/leather, and a tailgate inner surface is covered with extra trim panel. These secondary operations could increase the overall costs of manufacturing thermoplastic composite hybrid technology is currently limited to non-visible semi-structural or structural parts.

### BRIEF SUMMARY

The embodiments are directed to a thermoplastic composite hybrid part manufactured with a two-shot injection over-molding tool and process, which combines injection over-molding of structural features (ribbing or honeycomb) and aesthetic aspects on either side of the CFRTP in a single injection over-molding step.

One embodiment discloses a tool for manufacturing a part that is an over-molded structural thermoplastic composite hybrid part having a substrate, or composite insert, that is shaped, a reinforcement structure formed of a first material that is injection over-molded onto its inner surface, and an aesthetic layer formed of a second material that is injection over-molded onto its outer surface, the tool including: a first die that extends from a first die end to a second die end, wherein the first die extends from a first surface of the first die to a second surface of the first die; a second die that extends from a first end to a second end, wherein the second die extends from a first surface of the second die that faces the first surface of the first die to a second surface of the second die that faces away from the first die; wherein the first die includes a first block that is adjacent to the first end of the first die and extends outwardly from the first surface, the first block has a first block shape that matches a profile of the substrate; wherein the second die includes a first cavity that is adjacent to the first end of the second die and a second cavity that is adjacent to the second end of the second die, wherein the first and second cavities are adjacent to each other, and each cavity extends inwardly from the first surface toward the second surface of the second die; and wherein the first die is configured to rotate between a first rotational position and a second rotational position, wherein in the first rotational position, the first block is positioned to face the first cavity and not the second cavity, and in the second rotational position, the first block is positioned to face the second cavity and not the first cavity.

Another embodiment provides a method of manufacturing, with a tool, a part that is an over-molded structural thermoplastic composite hybrid part having a substrate, or composite insert, that is shaped and has an inner surface and an outer surface, a reinforcement structure formed of a first material that is over-molded onto the inner surface, and an outer aesthetic layer formed of a second material that is over-molded onto the outer surface, the method including: heating the substrate; positioning the substrate in the tool, wherein the tool has a first die that extends from a first die end to a second die end and a second die that extends from a first end to a second end, wherein the first die of the tool is in a first rotational position so that the substrate is between a first block that is adjacent to the first die end of the first die and a first cavity that is adjacent to the first end of the second die; closing the tool so that the first die is against the second die, and so that the substrate is pressed into a first mold chamber formed between the first block and the first cavity; injecting the first material into reinforcement grooves of the first block that face a first surface of the first die, via a first pour channel that extends from a second surface of the second die to the first cavity, to over-mold the reinforcement structure on the inner surface of the substrate; opening the tool and moving the first die from the first rotational position to a second rotational position, so that the first block is positioned to face a second cavity that is adjacent to the second end of the second die; closing the tool so that the substrate is inserted into a second mold chamber formed between the first block and the second cavity, so that a gap is formed between the outer surface of the substrate and the second cavity; injecting the second material into a second pour channel, that extends from the second end of the second die to the second cavity, to over-mold the outer aesthetic layer onto the outer surface of the substrate; and opening the tool and ejecting the part.

Another embodiment provides a method of manufacturing, with a tool, a part that is an over-molded structural thermoplastic composite hybrid part having a first substrate, or composite insert, that is shaped and has an inner surface and an outer surface, a reinforcement structure formed of a first material that is over-molded onto the inner surface, and an outer aesthetic layer formed of a second material that is over-molded onto the outer surface, the method including: heating the first substrate; positioning the first substrate in the tool, wherein the tool has a first die that extends from a first die end to a second die end and a second die that extends from a first end to a second end, wherein the first die of the tool is in a first rotational position so that the first substrate is between a first block that is adjacent to the first end of the first die and a first cavity that is adjacent to the first end of the second die, and a second block that is adjacent to a second die end of the first die is positioned to face a second cavity that is adjacent to the second end of the second die; closing the tool so that the first die is against the second die, and so that the first substrate is pressed into a first mold chamber that is formed between the first block and the first cavity, and the second block is positioned in the second cavity; injecting the first material into first reinforcement grooves of the first block via the first pour channel to over-mold the reinforcement structure onto the inner surface of the first substrate; opening the tool and moving the first die from the first rotational position to a second rotational position, so that the first block is positioned to face the second cavity, and the second block is positioned to face the first cavity; heating a second substrate; positioning the second substrate between the second block and the first cavity; closing the tool so that the first substrate is inserted into a second mold chamber formed between the first block and the second cavity so that a gap is formed between the outer surface of the first substrate and the second cavity, and the second substrate is pressed into the first mold chamber formed between the second block and the first cavity; injecting the second material into the second pour channel to over-mold the outer aesthetic layer on the outer surface of the first substrate, and the first material is injected through the first pour channel and into second reinforcement grooves in the second block to over-mold the reinforcement structure on the inner surface of the second substrate; and opening the tool and ejecting the part.

### BRIEF DESCRIPTION OF THE DRAWINGS

The present disclosure is illustrated by way of example and not limited in the accompanying figures in which like reference numerals indicate similar elements.

FIG. 1A shows a tool having two mold cavities and a single mold, for manufacturing a thermoplastic composite hybrid part with an internal reinforcement structure and an external aesthetic layer, according to an embodiment, where the tool has first and second die, with the first die in a first position so that a first mold of the first die faces a first cavity of two cavities of the second block, the tool is closed, and the first mold is in the first cavity.

FIG. 1A1 shows a perspective view of the first die, where the first die is cut along line A-A to provide the image shown in FIG. 1A.

FIG. 1A2 shows a perspective view of a shaped substrate laminate with a center opening that allows for material to pass through it when forming a reinforcement structure on the substrate laminate.

FIG. 1B shows a thermoplastic composite hybrid part with an internal reinforcement structure, and external aesthetic layer, manufactured with the tool of FIG. 1A.

FIG. 1C shows the tool of FIG. 1A, with first and second dies separated from each other.

FIG. 1D shows the tool of FIG. 1A, with the first die in a second rotational position in which the mold faces a second cavity of the two cavities.

FIG. 2 shows the tool of FIG. 1A, where the tool is closed and the mold is in the second cavity.

FIG. 3 shows the tool as shown in FIG. 1C in which additional features of the tool are identified.

FIG. 4A shows the tool as shown in FIG. 1A in which additional features of the tool are identified.

FIG. 4B shows the tool as shown in FIG. 1C in which additional features of the tool are identified.

FIG. 5 shows the tool as shown in FIG. 1A in which additional features of the tool are identified.

FIG. 6 shows another tool having two mold cavities and two molds, for manufacturing the thermoplastic composite hybrid part with an internal reinforcement structure, and an external aesthetic layer, according to an embodiment, where the tool is closed, and the first mold is in a first cavity of the two cavities and a second mold is in a second cavity of the two cavities.

FIGS. 7A-7H show the process for manufacturing the over-molded structural thermoplastic composite hybrid part with aesthetic integration using an in-mold formed substrate in a single step, two shot injection over-molding by utilizing a single-core and two-cavity tool according to the embodiments, where multiple parts may be manufactured in series relative to each other.

FIG. 8 is a flowchart showing the process illustrated in FIGS. 7A-7H.

FIGS. 9A-9C show the process for manufacturing the over-molded structural thermoplastic composite hybrid part with aesthetic integration using a pre-formed substrate in a two step, two shot injection over-molding by utilizing a single-core and two-cavity tool according to the embodiments, where multiple parts may be manufactured in series relative to each other.

FIG. 10 is a flowchart showing the process illustrated in FIGS. 9A-9C.

FIGS. 11A-11J show another process for manufacturing the over-molded structural thermoplastic composite hybrid part with aesthetic integration using an in-mold formed substrate in a one step, two shot injection over-molding by utilizing a two-core and two-cavity tool according to the embodiments, where multiple parts may be manufactured in parallel relative to each other.

FIG. 12 is a flowchart showing the process illustrated in FIGS. 11A-11J.

FIGS. 13A-13H show another process for manufacturing the over-molded structural thermoplastic composite hybrid part with aesthetic integration using a pre-formed substrate in a two step, two shot, injection over-molding, utilizing a two-core and two-cavity tool according to the embodiments, where multiple parts may be manufactured in parallel relative to each other.

FIG. 14 is a flowchart showing the process illustrated in FIGS. 13A-11H.

FIG. 15 shows an interior view of an over-molded structural thermoplastic composite part with aesthetic integration manufactured according to the embodiments.

FIG. 16 shows an exterior view of an over-molded structural thermoplastic composite hybrid part with aesthetic integration manufactured according to the embodiments.

### DETAILED DESCRIPTION

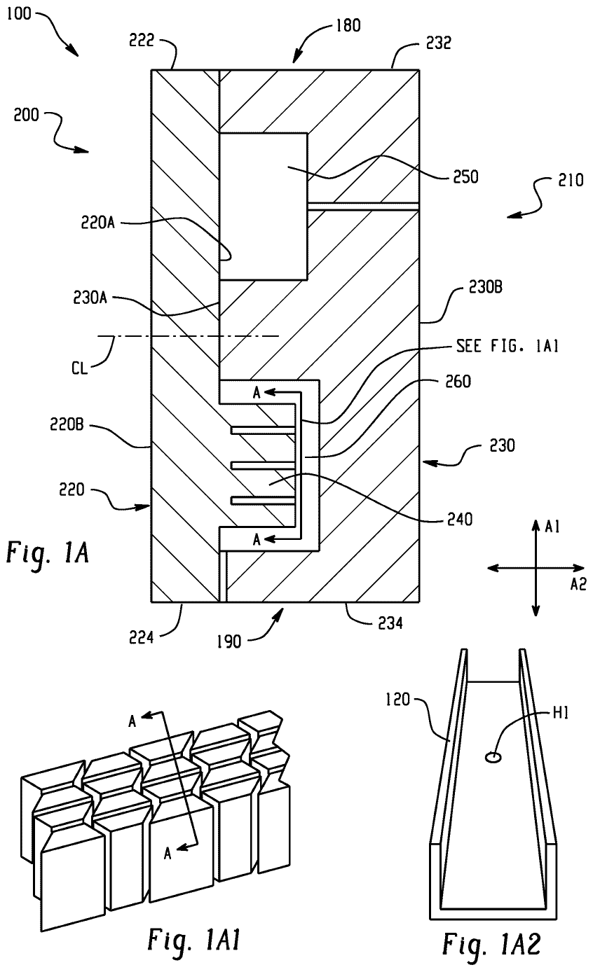

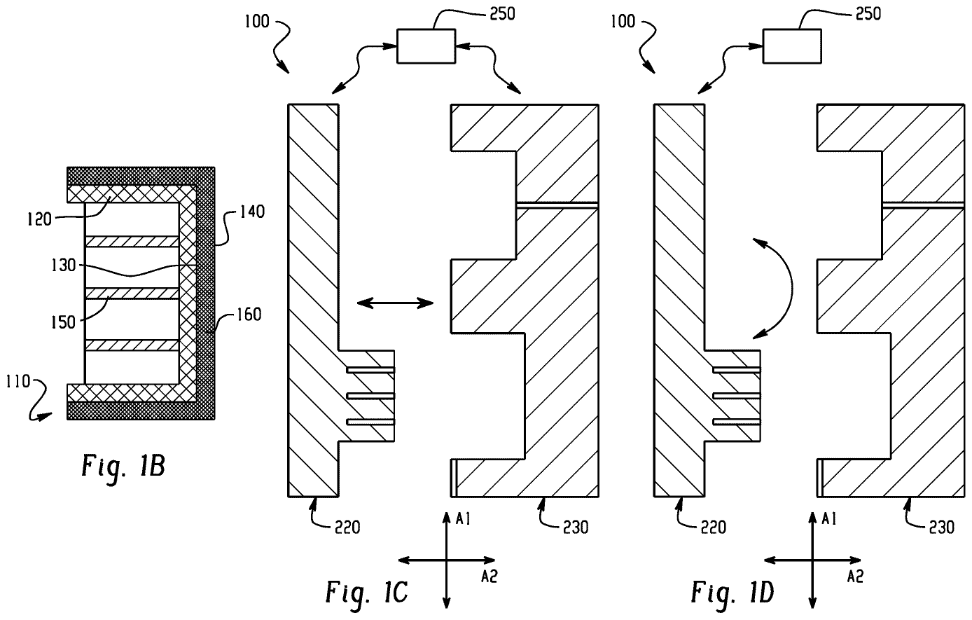

Turning to FIG. 1A, a tool 100 is disclosed herein for manufacturing a thermoplastic composite hybrid part 110 (FIG. 1B). The part 110 has a shaped substrate laminate (or substrate) 120, which may be C-shaped, that is, have a C-shape cross section, with an inner surface 130 and an outer surface 140. A reinforcement structure 150 is over-molded onto its inner surface 130, and an outer aesthetic layer 160 is over-molded onto its outer surface 140. The reinforcement structure 150 can be a long fiber filled thermoplastic material, and the outer aesthetic layer 160 can be a soft-touch chopped short fiber thermoplastic material.

The tool 100 extends along a first axis A1 from a first end 180 to a second end 190 and along a second axis A2 that is normal to the first axis A1 from a first side 200 to a second side 210. The tool 100 includes a first die (otherwise known as a male die plate, a core die, or generically a first platen) 220 and a second die plate or second die (otherwise known as a female die plate or die, or generically a second platen) 230 that are parallel with each other along the first axis A1. The first die 220 or the second die 230 is configured to move along the second axis A2 from a first translational position (FIG. 1c) in which the first and second die 230, 240 are spaced apart from each other and a second translational position (FIG. 1a) in which the first and second die 230, 240 engage each other. Such motion may be accomplished by an implement 250 which may be a motor, a robot, etc.

The first die 220 extends along the first axis A1, from a first end 222 (or first die end) to a second end 224 (or second die end). The second die 230 extends along the first axis A1, from a first end 232 to a second end 234. The first die 220 extends along the second axis A2 from the first surface 220A that faces the second die 230 to a second surface 220B that faces away from the second die 230. The second die 230 extends along the second axis A2 from a first surface 230A that faces the first die 220 to a second surface 230B that faces away from the first die 220.

The first die 220 includes a first block (otherwise known as a projection or core) 240 that has a first block shape, which may be rectangularly shaped, that matches the inner surface of the shaped substrate of the composite part. A perspective view of the first block 240 of the first die 220 is shown in FIG. 1A1. That is, the cross section in FIG. 1A is obtained by cutting the first block 240 of the first die 220 along line A-A in FIG. 1A1. FIG. 1A2 shows a perspective view of a shaped substrate laminate 120 with a center opening H1 that allows for material to pass through it when forming a reinforcement structure on the substrate laminate 120. The first block 240 extends outwardly from the first surface 220A of the first die 220. The second die 230 includes a first cavity 250 that is formed adjacent to the first end 232 of the second die 230 and a second cavity 260 that is formed adjacent to the second end 234 of the second die. Each cavity 250, 260, extends inwardly from the first surface 230A toward the second surface 230B of the second die 230. The first and second cavities 250, 260b are adjacent to each other along the first axis A1.

The first die 220 is configured to rotate (or pivot) about its center CL, i.e., its center axis that is along the second axis A2, between a first rotational position (FIG. 1c) and a second rotational (or pivotal) position (FIG. 1d). Such rotation can be accomplished by an implement 250, such as indicated above and rotating the first die 220 by 180 degrees about its center CL. In the first rotational position (FIG. 1d), the first block 240 is configured for insertion into the first cavity 250 and not the second cavity 260. In the second rotational position (FIG. 1d), the first block is configured for insertion into the second cavity 260 and not the first cavity 250 (FIG. 2).

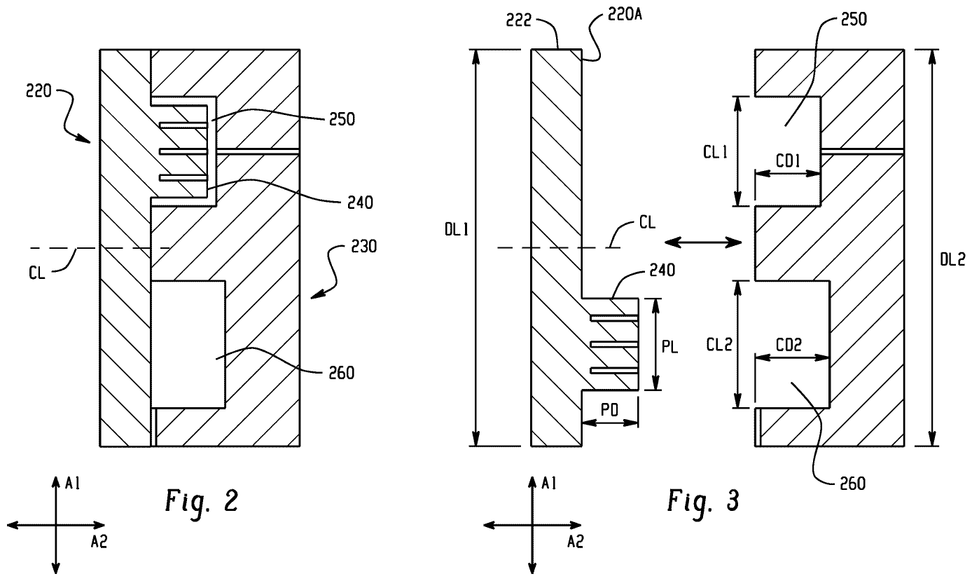

Turning to FIG. 3, the first die 220 extends along the first axis A1 by a first die length DL1. The second die 230 extends along the first axis A1 by a second die length DL2 that can be the same as the first die length DL1. The first block 240 extends outwardly from the first surface 220A of the first die 220 along the second axis A2 by a first block depth PD. The first block 240 extends along the first axis A1 by a first block length PL that is less than half the first die length DL1. The first block 240 is adjacent to the first end 180 of the first die 220 and is contained between the first end 180 of the first die 220 and the center CL of the first die 220.

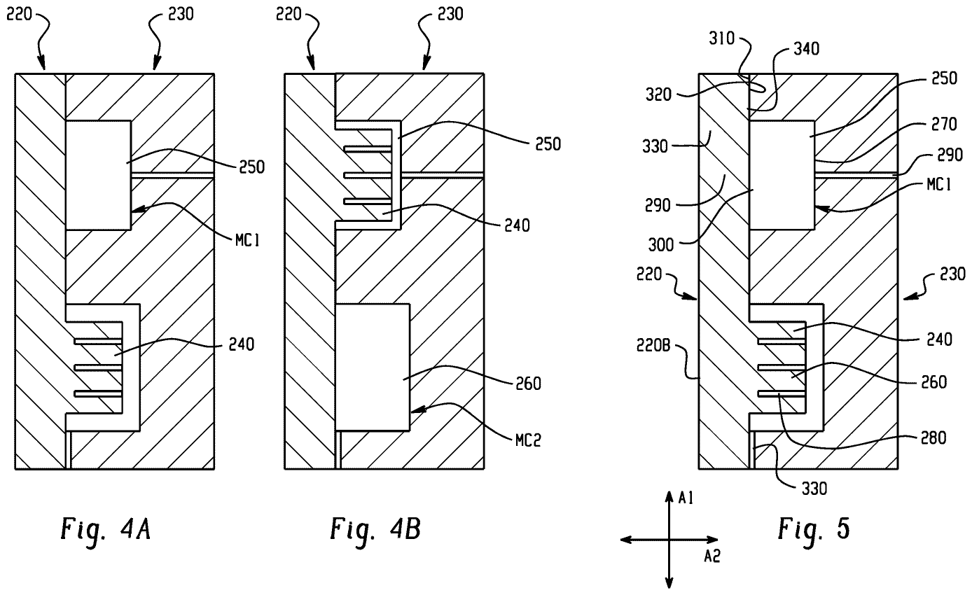

The first cavity 250 has a first cavity shape, that can be cup-shaped, that is complementary to the first block shape and extends inwardly from the first surface 220B of the second die 230 along the second axis A1 by a first cavity depth CD1 that is greater than the first block depth PD. The first cavity 250 extends along the first axis A1 by a first cavity length CL1 that is greater than the first block length PL. As shown in FIG. 4A, a first mold chamber MC1 is defined between the first block 240 and the first cavity 250 when the first die 220 is positioned against the second die 230 during operation of the tool 100, when shaping the substrate 120 or enclosing the substrate 120 that was previously shaped.

The second cavity 260 is larger than the first cavity 250. The second cavity 260 has a second cavity shape that is complementary to the first block shape. The second cavity 260 extends inwardly from the first surface 230A of the second die 230 along the second axis A2 by a second cavity depth CD2 that is larger than the first cavity depth CD1. The second cavity 260 extends along the first axis A1 by a second cavity length CL2 that is larger than the first cavity length CL1. As shown in FIG. 4B, a second mold chamber MC2 that is larger than the first mold chamber MC1 is defined between the first block 240 and the first cavity 250 when the first die 220 is positioned against the second die 230 for the over-molding of the aesthetic layer 160 about the outer surface 140 on the part 110.

Turning to FIG. 5, the first surface 220A of the first die 220, along the first block 240, defines an outer block surface 270. A (first) reinforcement groove 280 is defined in the first block 240, extending from the outer block surface 270 along the second axis A1 toward the second surface 220B of the first die 220. The reinforcement groove 280 can be shaped as a rib or honeycomb structure, i.e., having a rib shape or honeycomb shape. A first pour channel 290 is defined in the second die 230, extending from the second surface 230B of the second die 230 to the first cavity 250. From this configuration, liquid material is configured to flow into the reinforcement groove 280 to form the reinforcement structure 150 against the inner surface 130 of the substrate 120 of the composite part. The reinforcement groove 280 can be a (first) plurality of reinforcement grooves 280, extending from the outer block surface 270 along the second axis A2 toward the second surface 220A of the first die 220.

The first surface 220A of the first die 220, except where the first block 240 is located, defines a first outer lip 310. That is, the first outer lip 310 surrounds the first block 240. The first surface 230A of the second die 230, except where the block cavities 250, 260 are located, defines a second outer lip 320. That is, the second outer lip 320 surrounds the block cavities 250, 260. The first and second outer lips 310, 320 face each other and are against each other when the first die 220 is positioned against the second die 230.

A second pour channel 330 is defined in the second die 230, extending from the second end 234 of the second die 20 to the second cavity 260, which enables liquid material to flow into the second mold chamber MC2 when the first block 240 is disposed in the second cavity 260, as indicated below.

With the tool 100 disclosed above, the first die 220 has only one block, which is the first block 240, so that the tool 100 can process a single part 110 per operation of the tool 100.

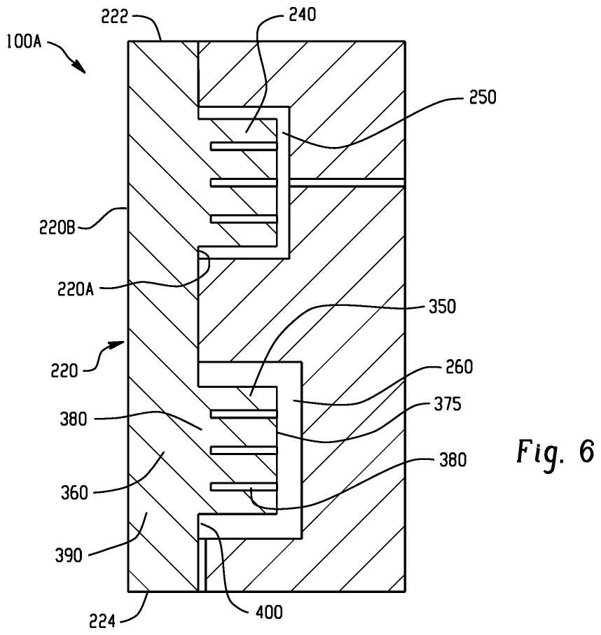

Turning to FIG. 6, the tool 100A has all the same features and functionality of the tool 100 disclosed above except that the first die 220 includes a second block 350, projecting outwardly from the first surface 220A of the first die 220. The second block 350 is configured the same, and is the same size, as the first block 240, and is adjacent to the first block 240 along the second axis A2. For example, a (second) reinforcement groove 370 is formed in the second block 350 that extends inwardly from an outer block surface 375. As with the first block 240, the reinforcement groove 370 can be a (second) plurality of reinforcement grooves. A first outer lip 310 surrounds the first and second blocks 240, 350. In the first rotational position of the first die 220, the second protection 350 is configured for insertion into the second cavity 260 and not the first cavity 250. In the second rotational position, the second block 350 is configured for insertion into the first cavity 250 and not the second cavity 260.

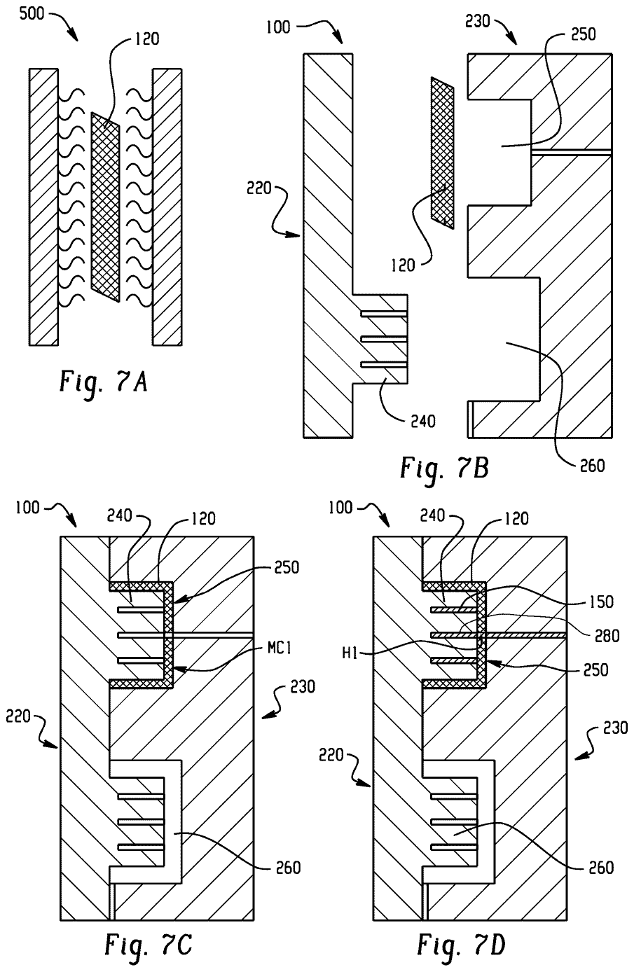

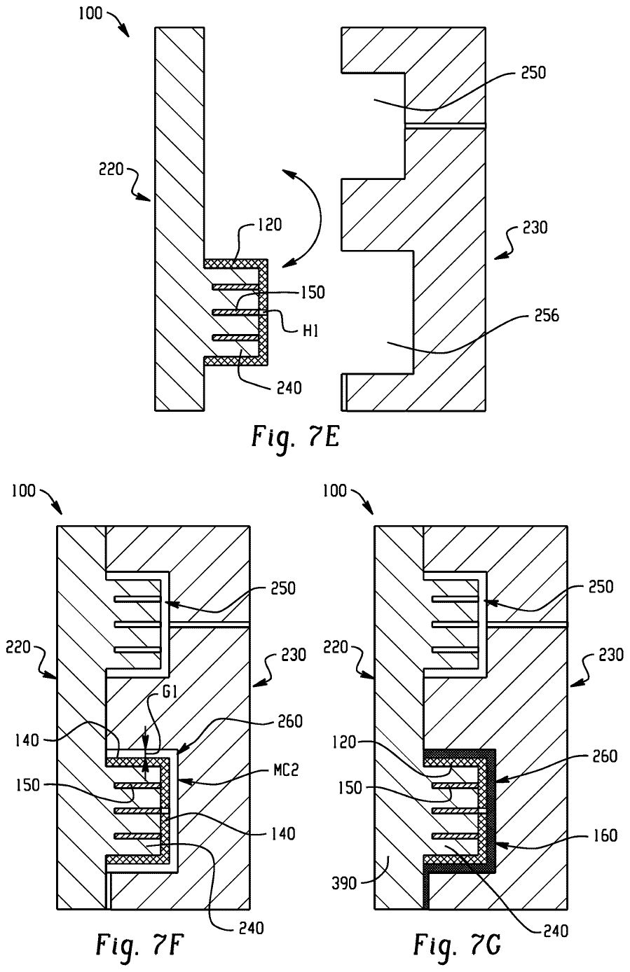

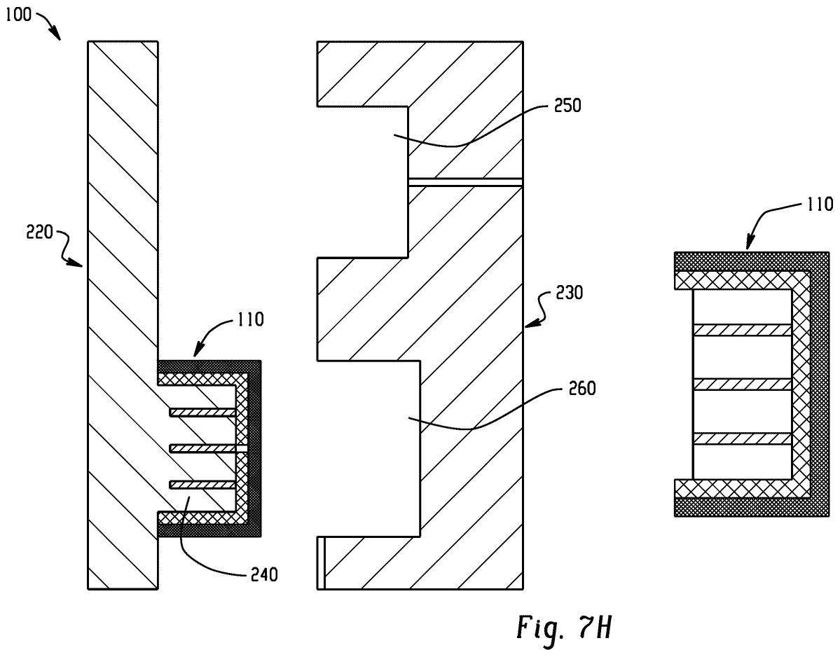

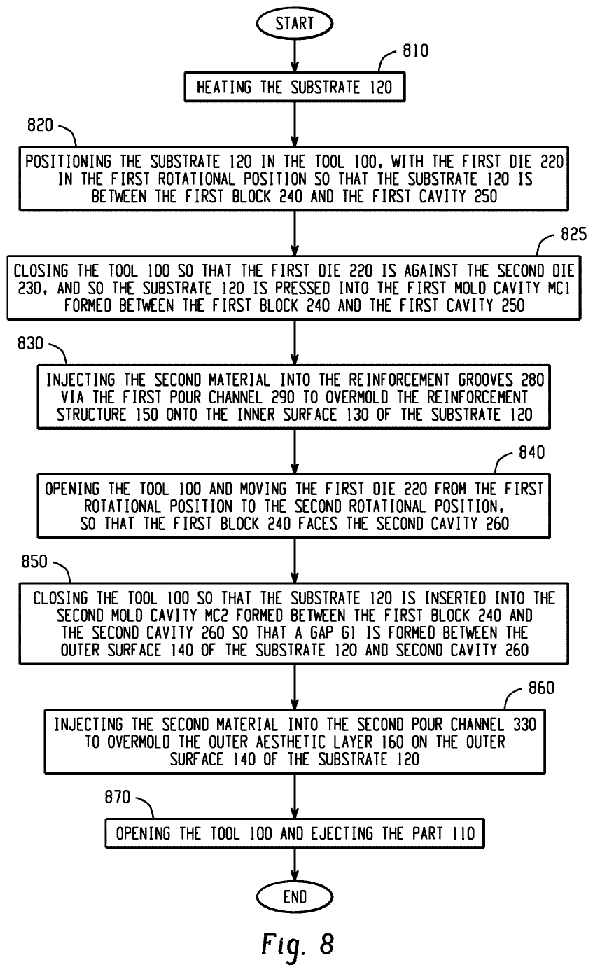

Turning to FIGS. 7 and 8, a method of manufacturing the part 110 is shown using the tool 100. As shown in FIG. 7A and block 810, the method includes heating the substrate 120 with a heating implement 500, which can be a typical laminate heater, which as shown in FIG. 7A is a flat sheet. That is, the substrate 120 can have a planar cross section and be thermoplastic composite laminate blank that is a continuous fiber reinforced thermoplastic (CFRTP) composite laminate. As shown in FIG. 7B and block 820, the method includes positioning the substrate 120 in the tool 100, with the first die 220 in the first rotational position so that the substrate 120 is between the first block 240 and the first cavity 250. As shown in FIG. 7C and block 825, the method includes and closing the tool 100 so that the first die 220 is against the second die 230, and so that the substrate 120 is pressed into the first mold chamber MC1 formed between the first block 240 and the first cavity 250. This process thermoforms the substrate 130 into a C-shaped insert.

As shown in FIG. 7d and block 830, the method includes injecting a first material into the reinforcement grooves 280 via the first pour channel 290 to over-mold the reinforcement structure 150 on the inner surface 130 of the substrate 120. This process, also known as a 1K (or first) shot, can utilize SABIC STAMAX® 40YM240 material for the reinforcement structure 150, or any long fiber filled thermoplastic resins. Fiber could be carbon, glass fiber or any other reinforcement. Material flows from first pour channel 290 of the second die 230 to the reinforcement grooves 280 of the first block 240 of the first die 220 via a hole H1 in the substrate 120. As shown in FIG. 7E and block 840, the method includes opening the tool 100 and moving the first die 220 from the first rotational position to the second rotational position, so that the first block 240 is configured to engage (e.g., faces) the second cavity 260. As shown in FIG. 7F and block 850, the method includes closing the tool 100 so that the substrate 120 is inserted into the second mold chamber MC2 formed between the first block 240 and the second cavity 260. As the second mold chamber MC2 is larger than the first mold chamber MC1, a gap G1 is formed between the outer surface 140 of the substrate 120 and second cavity 160. As shown in FIG. 7G and block 860, the method includes injecting a second material into the second pour channel 330 to over-mold the outer aesthetic layer 160 on the outer surface 140 of the substrate 120. This process, also known as a 2K (or second) shot, can utilize SABIC HAPSOFT™ PPcompound with desired colors as the material for the aesthetic layer 160, or any chopped (short) fiber filled, soft-touch thermoplastic resins. Fiber could be carbon, glass fiber or any other reinforcement. The composite hybrid part 110 is thereby formed. As shown in FIG. 7G and block 870, the method includes opening the tool 100 and ejecting the part 110. The process is repeated from blocks 810 to 870, e.g. as shown in FIGS. 7A to 7H, to form multiple parts 110.

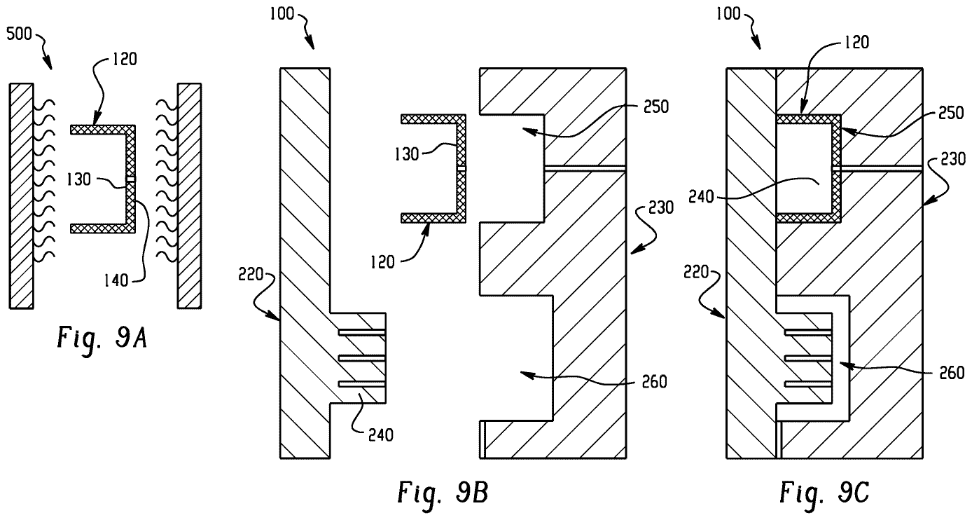

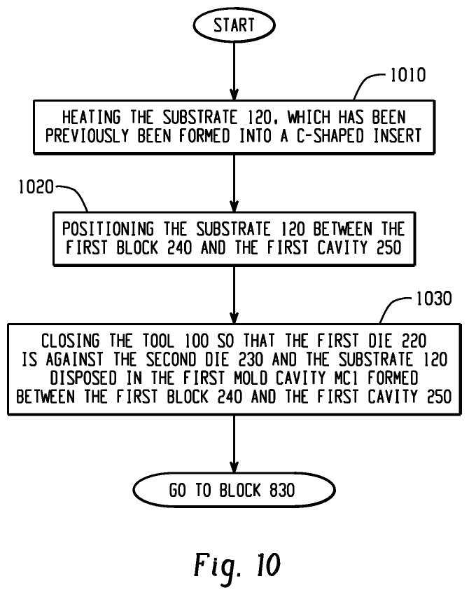

Turning to FIGS. 9 and 10, another method of manufacturing the part 110 is shown using the tool 100. At block 1010, the method includes heating the substrate 120, which as shown in FIG. 9A has been previously formed into a C-shape insert. Such shaping could occur by using a separate or build-up method. As shown in FIG. 9B and block 1020, the method includes positioning the substrate 120 in the tool 100, with the first die 220 in the first rotational position so that the substrate 120 is between the first block 240 and the first cavity 250. As shown in FIG. 9C and block 1030, the method includes closing the tool 100 so that the first die 220 is against the second die 230 and the substrate 120 disposed in the first mold chamber MC1 formed between the first block 240 and the first cavity 250. The remaining process is the same as shown in FIGS. 7D-7H and blocks 830-870.

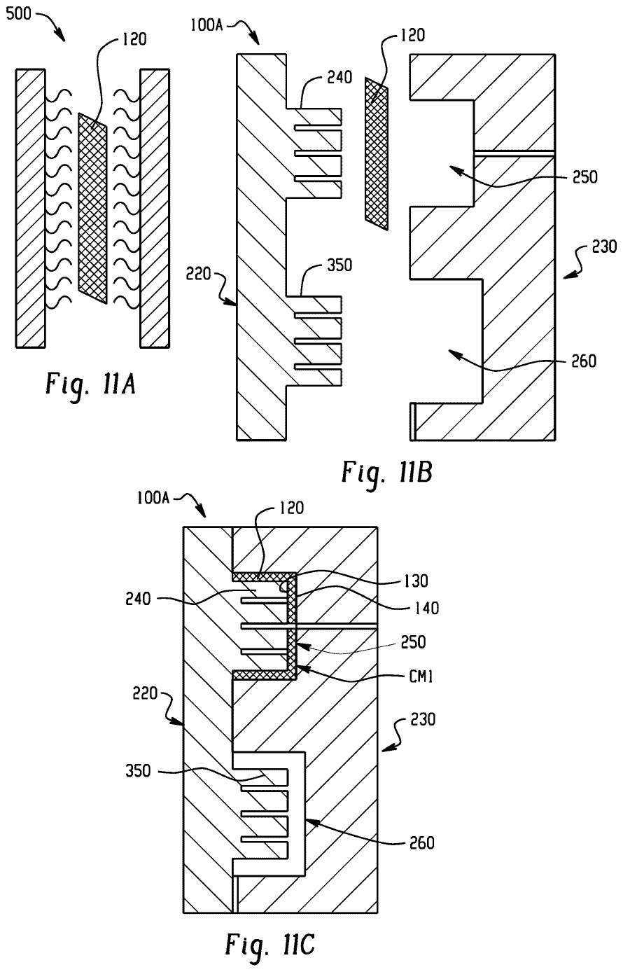

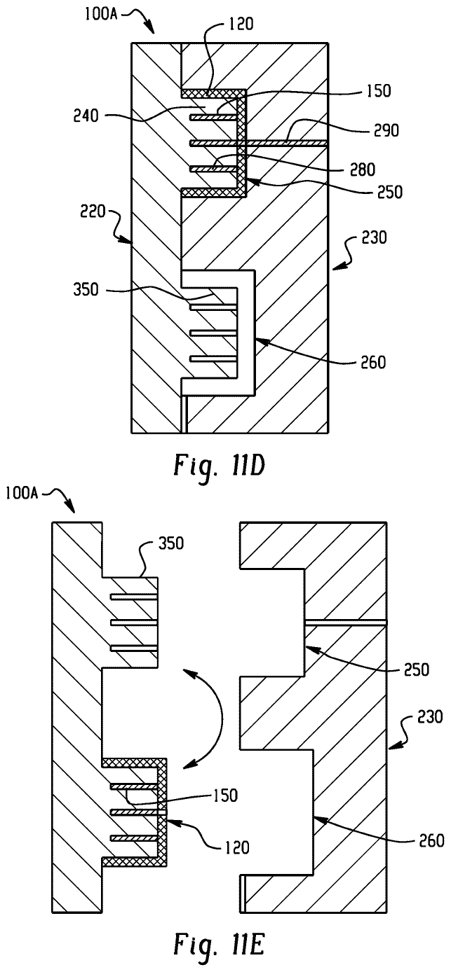

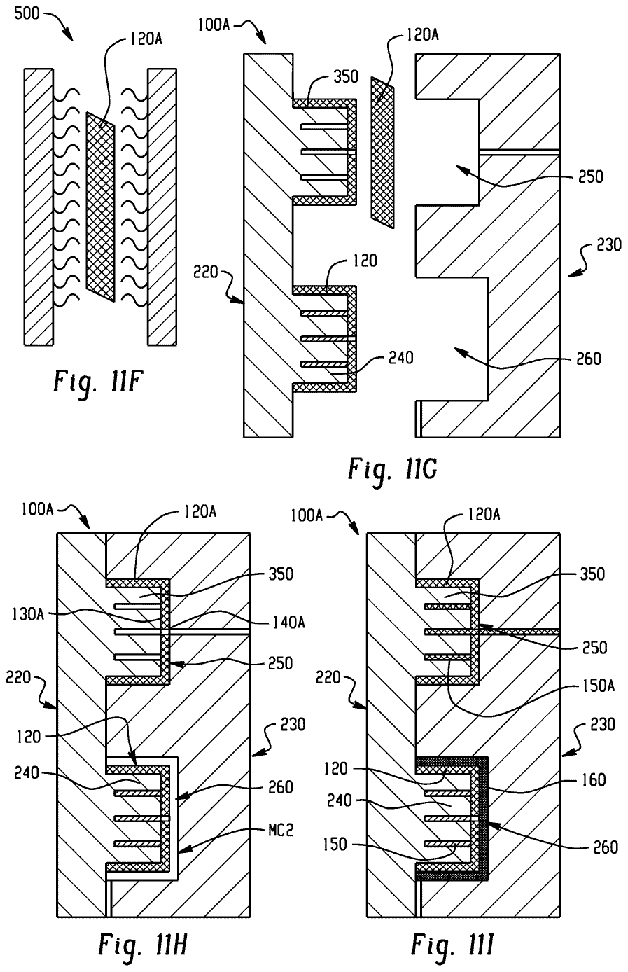

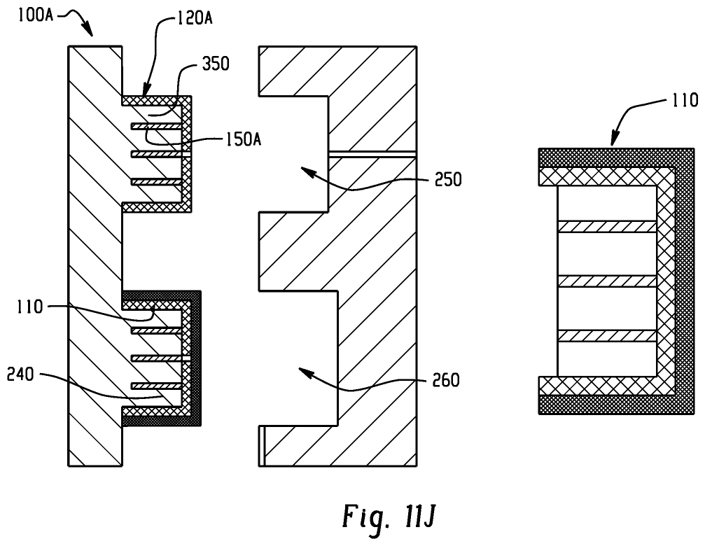

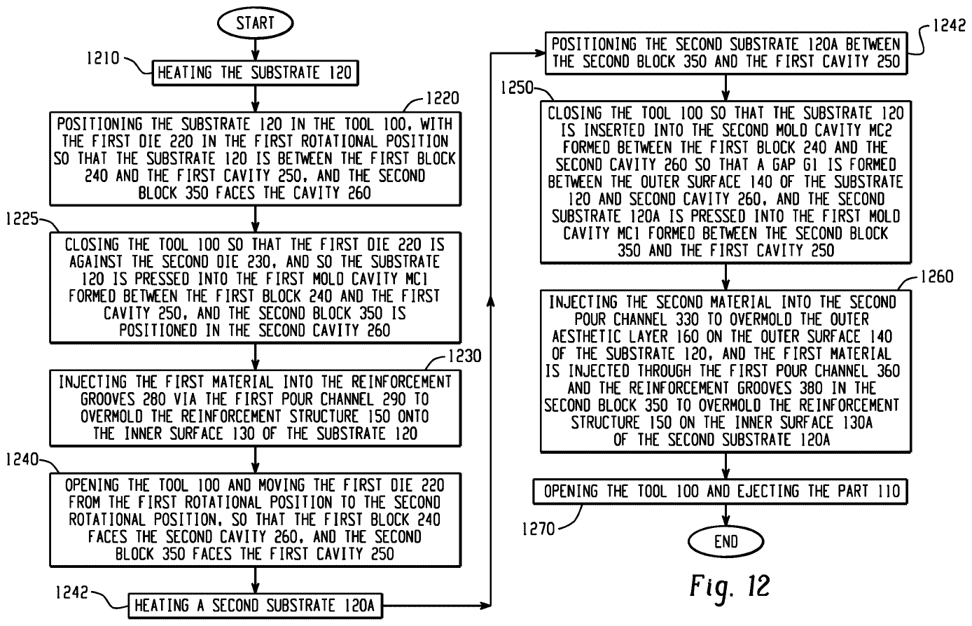

Turning to FIGS. 11 and 12, a method of manufacturing the part 110 is shown using the tool 100A. As shown in FIG. 11A and block 1210, the method includes heating the substrate (or first substrate) 120, which as shown in FIG. 11A is a flat sheet. As shown in FIG. 11B and block 1220, the method includes positioning the substrate 120 in the tool 100A, with the first die 220 in the first rotational position so that the substrate 120 is between the first block 240 and the first cavity 250 and the second block 350 faces the second cavity 260. As shown in FIG. 11C and block 1225, the method includes closing the tool 100A so that the first die 220 is against the second die 230, and so that the substrate 120 is pressed into the first mold chamber MC1 formed between the first block 240 and the first cavity 250. Simultaneously, the second block 350 is positioned in the second cavity 260. This process thermoforms the substrate 130 into a C-shaped insert.

As shown in FIG. 11D and block 1230, the method includes injecting the first material into the reinforcement grooves 280 via the first pour channel 290 to over-mold the reinforcement structure 150 onto the inner surface 130 of the substrate 120. As shown in FIG. 11E and block 1240, the method includes opening the tool 100A and moving the first die 220 from the first rotational position to the second rotational position. In this configuration, the first block 240 is faces the second cavity 260 and the second block 350 faces the first cavity 250.

As shown in FIG. 11F and block 1244, the method includes heating a second substrate 120A, which as shown in FIG. 11F is a flat sheet. As shown in FIG. 11G and block 1246, the method includes positioning the second substrate 120A between the second block 350 and the first cavity 250.

As shown in FIG. 11H and block 1250, the method includes closing the tool 100A so that the first block 240 is inserted into the second mold chamber MC2 formed between the first block 240 and the second cavity 260. As the second mold chamber MC2 is larger than the first mold chamber MC1, a gap G1 is formed between the outer surface 140 of the substrate 120 and second cavity 160. Simultaneously, the second substrate 120A is pressed into the first mold chamber MC1 formed between the second block 350 and the first cavity 250. This process thermoforms the second substrate 120A into a C-shaped insert that matches the shape of the substrate 120, such that the second substrate 120A has an inner surface 130A and an outer surface 140A.

As shown in FIG. 11I and block 1260, the method includes injecting the second material into the second pour channel 330 to over-mold the outer aesthetic layer 160 on the outer surface 140 of the substrate 120. The composite part 110 is thereby formed. Simultaneously material is injected through the first pour channel 290 and the reinforcement grooves 380 in the second block 350 to over-mold the reinforcement structure 150 on the inner surface 130A of the second substrate 120A. As shown in FIG. 12J and block 1270, the tool A is opened and the part 110 is removed from the tool 100A. The process is repeated from blocks 1240 to 1270, e.g. as shown in FIGS. 11E to 11J, to form multiple parts 110. As can be appreciated, this process enables a faster production of multiple parts 110.

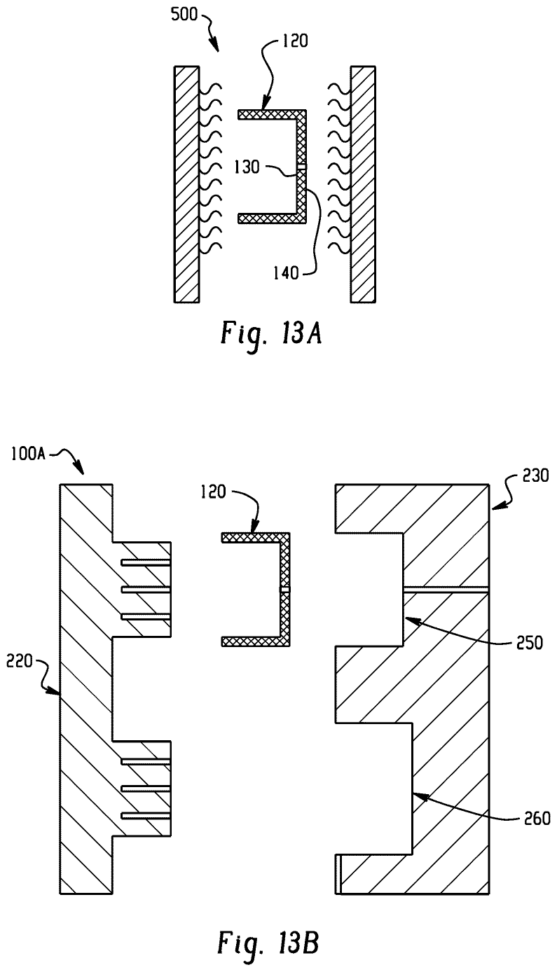

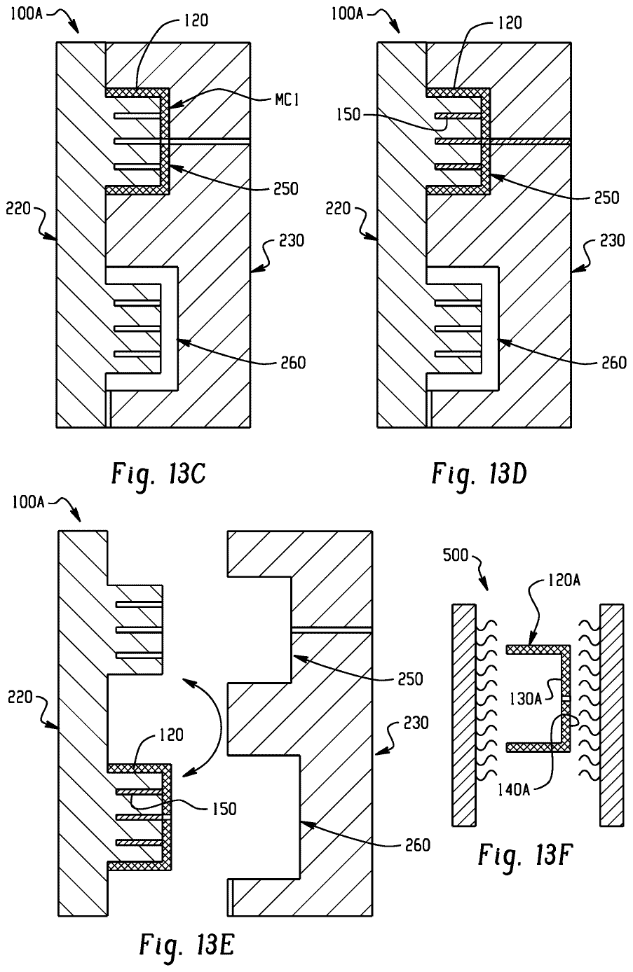

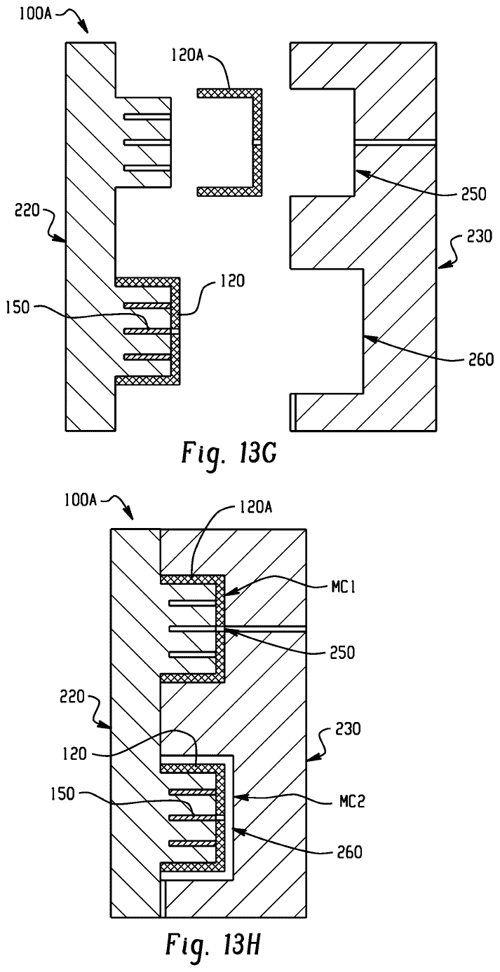

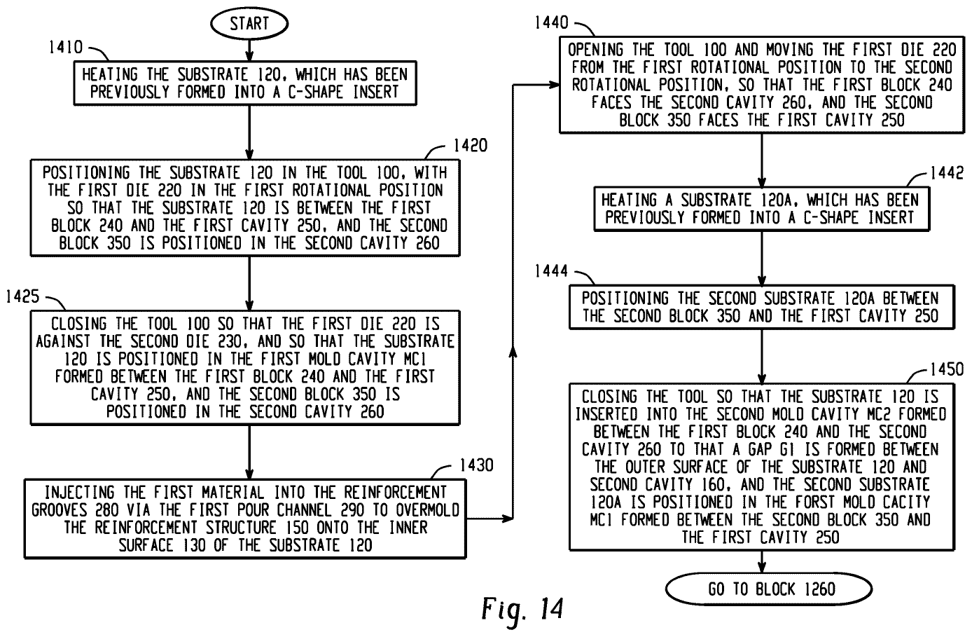

Turning to FIGS. 13 and 14, another method of manufacturing the part 110 is shown using the tool 100A. As shown in FIG. 13A and block 1410, the method includes heating the substrate 120, which as shown in FIG. 13A is already formed into C-shaped profile, similar to that shown in FIG. 9A. As shown in FIG. 13B and block 1420, the method includes positioning the substrate 120, with the first die 220 in the first rotational position so that the substrate 120 is between the first block 240 and the first cavity 250, and the second block 350 faces the second cavity 260. As shown in FIG. 13C and block 1425, the method includes closing the tool 100A so that the first die 220 is against the second die 230, and so that the substrate 120 is positioned within the first mold chamber MC1 formed between the first block 240 and the first cavity 250, and the second block 350 is positioned in the second cavity 260.

As shown in FIG. 13D and block 1430, the method includes injecting the first material into the reinforcement grooves 280 via the first pour channel 290 to over-mold the reinforcement structure 150 onto the inner surface 130 of the substrate 120. As shown in FIG. 13E and block 1440, the method includes opening the tool 100A and moving the first die 220 from the first rotational position to the second rotational position, so that the first block 240 is faces the second cavity 260, and the second block 350 faces the first cavity 250.

As shown in FIG. 13F and block 1444, the method includes heating a second substrate 120A, which as shown in FIG. 13F is already formed into C-shaped insert. As shown in FIG. 13G and block 1446, the method includes positioning the second substrate 120A between the second block 350 and the first cavity 250.

As shown in FIG. 13H and block 1450, the method includes closing the tool 100A so that the first block 240 is inserted into the second mold chamber MC2 formed between the first block 240 and the second cavity 260. As the second mold chamber MC2 is larger than the first mold chamber MC1, a gap G1 is formed between the outer surface 140 of the substrate 120 and second cavity 160. Simultaneously, the second substrate 120A is positioned in the first mold chamber MC1 formed between the second block 350 and the first cavity 250. The remaining process is the same as shown in FIG. 11I-11J and blocks 1260-1270 to form the part 110. The process can be repeated, starting with FIG. 13E and block 1440 to simultaneously make multiple parts 110.

The above disclosed process provides for manufacturing thermoplastic composite hybrid part with structural and aesthetic features injection over-molded on either side of the composite laminate substrate surface in 1-step 2-shot injection over-molding process. The automated process utilizes a pre-heated shaped CFRTP composite laminate substrate injection over-molded with a structural long fiber thermoplastic (LFT) resin on one side of the substrate in a first cavity of a two-cavity tool. The resulting structure is then injection over-molded with a soft-touch chopped (short) fiber filled thermoplastic resin on the other side of the substrate in a second cavity of the two-cavity tool to achieve a single-piece solution with potential to achieve improved aesthetics and haptics with desired colors representative of automotive outer and inner colors. This 1-step 2 -shot injection over-molding process can be achieved in acceptable cycle time, making it potentially suitable for mass production. The final finished part meets both the structural requirement and the aesthetic requirement for the automotive applications, thus avoid any secondary operations, and reduce part's manufacturing cost. Parts'manufacturing with such 1-step 2-shot thermoplastic composite hybrid injection over-molding technology can be applied in many automotive applications, such as tailgates, armrests, seating structures, dash panels, etc.

### EXAMPLES

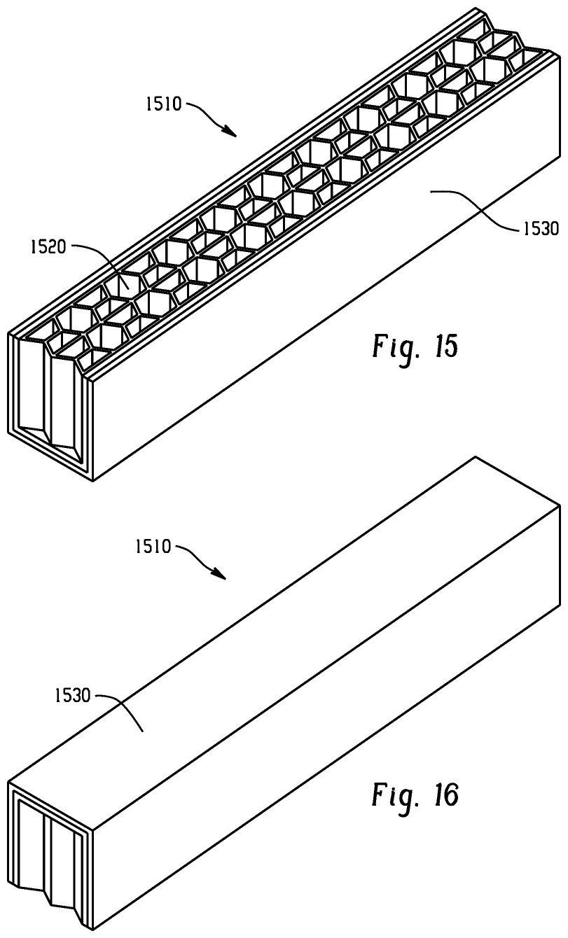

Turning to FIG. 15, over-molded onto the part 1510, the inner rib or honeycomb structure 1520 is obtained through a first injection over-molding process or 1K shot can contribute to improve buckling resistance and bending performance of the over-molded structural thermoplastic composite hybrid part 1510. It also contributes to higher energy absorption efficiency for improved crashworthiness. The combination of the composite laminate substrate with the 1K shot injection over-molding resin can provide the required amount of stiffness/strength with functional integration. The inner rib or honeycomb structure 1520 is obtained with SABIC STAMAX® 40YM240 which is a black colored long glass fiber thermoplastic resin, or any long fiber filled thermoplastic resins. Fiber could be carbon, glass fiber or any other reinforcement. The first cavity of the one-core and two-cavity tool and two-core and two-cavity tool is used to injection over-mold the rib or honeycomb structure. The outer aesthetic layer 1530 is obtained during the second injection over-molding with the soft touch chopped (short) fiber filled thermoplastic resin blended with a representative desired color (such as blue) for an automotive application.

Turning to FIG. 16, the outer layer 1530 of the soft touch material is obtained through a second injection over-molding process or 2K is for aesthetics and haptics. SABIC HAPSOFT™ PPcompound is a chopped glass fiber thermoplastic resin in natural color, or any chopped (short) fiber filled, soft-touch thermoplastic resins. Fiber could be carbon, glass fiber or any other reinforcement. This allows to blend SABIC HAPSOFT™ PPcompound with other color masterbatches, and thus to create representative automotive inner and outer colors. For example, blue, beige, grey, black, red and grey colors can be mixed with SABIC HAPSOFT™ PPcompound. The second cavity of the one-core and two-cavity tool and two-core two-cavity tool is used to injection over-mold the outer soft touch layer.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

1. A tool for manufacturing a part that is an over-molded structural thermoplastic composite hybrid part having a substrate, or composite insert, that is shaped, a reinforcement structure formed of a first material that is injection over-molded onto its inner surface, and an aesthetic layer formed of a second material that is injection over-molded onto its outer surface, the tool comprising:
a first die that extends from a first die end to a second die end, wherein the first die extends from a first surface of the first die to a second surface of the first die;
a second die that extends from a first end to a second end, wherein the second die extends from a first surface of the second die that faces the first surface of the first die to a second surface of the second die that faces away from the first die;
wherein the first die includes a first block that is adjacent to the first end of the first die and extends outwardly from the first surface, and the first block has a first block shape that matches a profile of the substrate;
wherein the second die includes a first cavity that is adjacent to the first end of the second die and a second cavity that is adjacent to the second end of the second die, with the first and second cavities adjacent to each other, and wherein each cavity extends inwardly from the first surface toward the second surface of the second die; and
wherein the first die is configured to rotate between a first rotational position and a second rotational position, wherein in the first rotational position, the first block is positioned to face the first cavity and not the second cavity, and in the second rotational position, the first block is positioned to face the second cavity and not the first cavity.

2. The tool of claim 1, wherein:
the first die extends by a first die length from the first die end to the second die end of the first die;
wherein the first block extends outwardly from the first surface of the first die by a first block depth, has a first block length that is less than half the first die length, and is adjacent to the first end of the first die;
wherein the first cavity has a first cavity shape that is complementary to the first block shape, extends inwardly from the first surface of the second die by a first cavity depth that is greater than the first block depth, and has a first cavity length that is greater than the first block length; and
wherein a first mold chamber is defined between the first block and the first cavity when the first die is positioned against the second die during operation of the tool.

3. The tool of claim 2, wherein the second die extends by a second die length that is the same as the first die length.

4. The tool of claim 3, wherein the second cavity is larger than the first cavity.

5. The tool of claim 4, wherein:
the second cavity has a second cavity shape that is complementary to the first block shape, extends inwardly from the first surface of the second die by a second cavity depth that is larger than the first cavity depth, and has a second cavity length that is larger than the first cavity length, and
a second mold chamber that is larger than the first mold chamber is defined between the first block and the first cavity when the first die is positioned against the second die.

6. The tool of claim 5, wherein:
the first surface of the first die, at the first block, defines an outer block surface;
wherein a reinforcement groove is defined in the first block, extending from the outer block surface toward the second surface of the first die; and
wherein a first pour channel is defined in the second die, extending from the second surface of the second die to the first cavity,
whereby the first material is configured to flow into the reinforcement groove to form the reinforcement structure against the inner surface of the substrate of the part.

7. The tool of claim 6, wherein:
the first surface of the first die, except where the first block is located, defines a first outer lip;
wherein the first surface of the second die, except where the first cavity and the second cavity are located, defines a second outer lip;
wherein the first outer lip and the second outer lip are positioned against each other when the first die is against the second die; and
wherein a second pour channel is defined in the second die, extending from the second end of the second die to the second cavity, whereby the second material is configured to flow into the second mold chamber.

8. The tool of claim 7, wherein:
the first die includes a second block that configured the same as the first block, and is adjacent to the first block; and
wherein, in the first rotational position of the first die, the second block is positioned to face the second cavity and not the first cavity, and in the second rotational position, the second block is positioned to face the first cavity and not the second cavity.

9. The tool of claim 8, wherein the substrate is a thermoplastic composite laminate blank that is a continuous fiber reinforced thermoplastic (CFRTP) composite laminate, the first material is a long fiber filled thermoplastic material, and the second material is a soft-touch chopped short fiber thermoplastic material.

10. A method of manufacturing, with a tool, a part that is an over-molded structural thermoplastic composite hybrid part having a substrate, or composite insert, that is shaped and has an inner surface and an outer surface, a reinforcement structure formed of a first material that is over-molded onto the inner surface, and an outer aesthetic layer formed of a second material that is over-molded onto the outer surface, the method comprising:
heating the substrate;
positioning the substrate in the tool, the tool having a first die that extends from a first end to a second end and a second die that extends from a first end to a second end, with the first die of the tool in a first rotational position so that the substrate is between a first block that is adjacent to the first end of the first die and a first cavity that is adjacent to the first end of the second die;
closing the tool so that the first die is against the second die, and so that the substrate is pressed into a first mold chamber formed between the first block and the first cavity;
injecting the first material into reinforcement grooves of the first block that face a first surface of the first die, via a first pour channel that extends from a second surface of the second die to the first cavity, to over-mold the reinforcement structure on the inner surface of the substrate;
opening the tool and moving the first die from the first rotational position to a second rotational position, so that the first block is positioned to face a second cavity that is adjacent to the second end of the second die;
closing the tool so that the substrate is inserted into a second mold chamber formed between the first block and the second cavity, so that a gap is formed between the outer surface of the substrate and the second cavity;
injecting the second material into a second pour channel, that extends from the second end of the second die to the second cavity, to over-mold the outer aesthetic layer onto the outer surface of the substrate; and
opening the tool and ejecting the part.

11. The method of claim 10, wherein:
the substrate has a C-shape cross section prior to being heated; or wherein the substrate has a planar cross section prior to being heated, and the substrate is formed into the C-shape cross section when pressed into the first mold chamber.

12. The method of claim 11, wherein the substrate is a thermoplastic composite laminate blank that is a continuous fiber reinforced thermoplastic (CFRTP) composite laminate, the first material is a long fiber filled thermoplastic material, and the second material is a soft-touch chopped short fiber thermoplastic material.

13. A method of manufacturing, with a tool, a part that is an over-molded structural thermoplastic composite hybrid part having a first substrate, or composite insert, that is shaped and has an inner surface and an outer surface, a reinforcement structure formed of a first material that is over-molded onto the inner surface, and an outer aesthetic layer formed of a second material that is over-molded onto the outer surface, the method comprising:
heating the first substrate;
positioning the first substrate in the tool, wherein the tool has a first die that extends from a first die end to a second die end and a second die that extends from a first end to a second end, wherein the first die of the tool is in a first rotational position so that the first substrate is between a first block that is adjacent to the first die end of the first die and a first cavity that is adjacent to the first end of the second die, and a second block that is adjacent to a second die end of the first die is positioned to face a second cavity that is adjacent to the second end of the second die;
closing the tool so that the first die is against the second die, and so that the first substrate is pressed into a first mold chamber that is formed between the first block and the first cavity, and the second block is positioned in the second cavity;
injecting the first material into first reinforcement grooves of the first block via the first pour channel to over-mold the reinforcement structure onto the inner surface of the first substrate;
opening the tool and moving the first die from the first rotational position to a second rotational position, so that the first block is positioned to face the second cavity, and the second block is positioned to face the first cavity;
heating a second substrate;
positioning the second substrate between the second block and the first cavity;
closing the tool so that the first substrate is inserted into a second mold chamber formed between the first block and the second cavity so that a gap is formed between the outer surface of the first substrate and the second cavity, and the second substrate is pressed into the first mold chamber formed between the second block and the first cavity;
injecting the second material into the second pour channel to over-mold the outer aesthetic layer on the outer surface of the first substrate, and the first material is injected through the first pour channel and into second reinforcement grooves in the second block to over-mold the reinforcement structure on the inner surface of the second substrate; and
opening the tool and ejecting the part.

14. The method of claim 13, wherein:
the first substrate has a C-shape cross section prior to being heated; or wherein the first substrate has a planar cross section prior to being heated, and the first substrate is formed into the C-shape cross section when pressed into the first mold chamber.

15. The method of claim 14, wherein the first substrate is a thermoplastic composite laminate blank that is a continuous fiber reinforced thermoplastic (CFRTP) composite laminate, the first material is a long fiber filled thermoplastic material, and the second material is a soft-touch chopped short fiber thermoplastic material.

16. The tool of claim 6, wherein the reinforcement groove is a plurality of reinforcement grooves, extending from the outer block surface toward the second surface of the first die.

17. The tool of claim 9, wherein the reinforcement structure is formed as a rib or a honeycomb shape.

18. The method of claim 12, wherein the reinforcement structure is formed as a rib or a honeycomb shape.

19. The method of claim 14, wherein the second substrate has the C-shape cross section prior to being heated; or wherein the second substrate has the planar cross section prior to being heated, and the second substrate is formed into the C-shape cross section when pressed into the first mold chamber.

20. The method of claim 15, wherein the reinforcement structure is formed as a rib or a honeycomb shape.
